(19) United States
(12) Patent Application Publication
(10) Pub. No.: US 2010/0070244 A1
(43) Pub. Date: Mar. 18, 2010

(54) SYSTEMS AND METHODS FOR THE ACTIVE DISPLAY AND UPDATING OF SITING PLANS

(76) Inventor: Robert NICOLUCCI, Richmond Hill (CA)

Correspondence Address: BERESKIN AND PARR LLP/S.E.N.C.R.L., s.r.l., 40 KING STREET WEST, BOX 401, TORONTO, ON, M5H 3Y2, CA

(21) Appl. No.: 12/559,264

(22) Filed: Sep. 14, 2009

Related U.S. Application Data
(60) Provisional application No. 61/096,873, filed on Sep. 15, 2008.

(51) Int. Cl. G06F 17/50; G06F 17/30; G06F 3/048

(52) U.S. Cl. 703/1; 715/764; 707/E17.005

(57) ABSTRACT

Systems and methods for updating and displaying the availability of models for at least one model to be sited on a set of at least one lot of a siting plan. The method includes: determining the at least one model; determining the availability of each model to be sited on each lot; displaying siting plan data corresponding to the siting plan (with the siting plan indicating the model availability for each lot); receiving a change to the model availability corresponding to a first lot in the set; determining any required change to the model availability for any of the lots in the set other than the first lot; and displaying siting plan data corresponding to an updated siting plan. The updated siting plan may reflect the received change to the model availability data for the first lot as well as the required changes to the model availability data for any of the lots in the set other than the first lot. Additionally, the method may include displaying a siting plan layout corresponding to the updated siting plan.

### PRIORITY

This application claims priority from U.S. provisional patent application No. 61/096,873, filed Sep. 15, 2008, which is incorporated by reference herein in its entirety.

### TECHNICAL FIELD

Embodiments described herein relate generally to real estate applications, and more specifically to systems and methods that provide for the active display and updating of real estate siting plans.

### BACKGROUND

Real estate projects typically permit potential buyers to choose from various available lots within the development project, and also to select one of the available models (and elevation of such selected model, if more than one is available) to be built on the chosen lot. Various potential lot/model combinations and permutations result. Further complicating the sales and selection process are the various architectural or siting rules restricting the location of various models within the project.

For example, to avoid a cookie-cutter appearance, the architectural rules for some models may require that the same model may not appear on adjacent lots (or be repeated within a certain number of adjacent lots). Conversely, the architectural rules may require that some models (single storey and/or townhouse models for example) must be assigned to two or more adjacent lots.

Accordingly, the inventor has recognized a need for systems and methods to facilitate the creation, displaying and updating of siting plans. As used below, the term “siting plan” may refer to information about lots, their relationships amongst each other, their respective ability to site one or more models on a lot, and corresponding images.

### BRIEF DESCRIPTION OF THE DRAWINGS

For a better understanding of example embodiments described herein, and to show more clearly how they may be carried into effect, reference will now be made, by way of example, to the accompanying drawings in which:

FIG. 1 is a block diagram of a siting plan system in one example implementation.

FIG. 2A is a schematic illustration of one embodiment of an example siting plan matrix as may be generated in accordance with the present disclosure.

FIG. 2B is an updated version of the siting plan matrix of FIG. 2A as updated upon receipt of a decision input reflecting the sale of a particular model on a particular lot.

FIG. 2C is an example screen shot of another embodiment of a siting plan matrix as may be generated in accordance with the present disclosure.

FIG. 3A is a schematic illustration of example model records containing exemplary data as may be stored in the model database of FIG. 1.

FIG. 3B is an example screen shot of various alternate exemplary architectural/siting rules as may stored in the model database of FIG. 1.

FIG. 4A is a schematic illustration of example image records containing exemplary data as may be stored in the image database of FIG. 1.

FIG. 4B is an example screen shot of image data of a lot/model combination, as may be selectively displayed.

FIG. 5 a flowchart illustrating steps of a method of displaying an active siting plan in accordance with at least one embodiment.

FIG. 6A is a top plan view of an example siting plan layout as may be generated in accordance with the present disclosure.

FIG. 6B is an updated version of the siting plan layout of FIG. 6A as updated upon receipt of decision input corresponding to the sale of a particular model on a particular lot.

### DETAILED DESCRIPTION

Embodiments described herein are generally directed to systems and methods for determining the availability of at least one model to be sited on at least one lot. Some embodiments of the system described herein may be implemented as a sales tool. During the selling process, a sales agent may be able to show prospective home buyers all available lots in a project and images of available house models/elevations for such lots. Once a lot and a house are sold, the applicable architectural control rules may be applied to related lots immediately. Accordingly, the siting analysis may be implemented in “real time”.

In a broad aspect, there is provided a model availability system for determining the availability of at least one model to be sited on at least one lot. The system includes a siting plan database, a display, an input module and an availability module. The siting plan database includes a plurality of lot records, with each lot record corresponding to one lot of a set of lots in a siting plan. Additionally, each lot record comprises model availability data corresponding to the availability of a plurality of models for the corresponding lot. The display is operatively coupled to the siting plan database and is configured to display siting plan data corresponding to the siting plan. In some embodiments, the display may also be configured to display a siting plan layout corresponding to the siting plan.

The input module is configured to receive input corresponding to at least one change to the model availability data for at least one of the lots. The availability updating module is operatively coupled to the input module and to the siting plan database. Upon receipt of a change to the model availability data for a first lot, the availability updating module is configured to determine any required change to the model availability data for any other lot.

The siting plan database may also include related lot data identifying how at least two lots are related. Related lot data may indicate that two lots are adjacent to each other, across the street from each other, back to back to each other or kitty corner to each other. The updating module may be configured with at least one siting rule for determining if a change is required to the model availability data for a lot. The availability updating module may also be configured to apply the at least one siting rule corresponding to the first lot.

A model database operatively coupled to the availability updating module may also be provided. The model database may include a plurality of model records, with each model record corresponding to one of the models. As well, each model record may include at least one siting rule for the corresponding model.

In some instances, a siting rule may require that for at least one of the models, the model may not be assigned to two adjacent lots. In addition or in the alternative, a siting rule may require that for at least one of the models, the model must be assigned to two adjacent lots. Furthermore, a siting rule may require that for at least one of the models, the model may not be assigned to two lots less than a predetermined number of lots apart.

Another broad aspect is directed towards a method of displaying the availability of models for at least one model to be sited on a set of at least one lot of a siting plan. The method includes: determining the at least one model; determining the availability of each model to be sited on each lot; displaying siting plan data corresponding to the siting plan (with the siting plan indicating the model availability for each lot); receiving a change to the model availability corresponding to a first lot in the set; determining any required change to the model availability for any of the lots in the set other than the first lot; and displaying siting plan data corresponding to an updated siting plan. The updated siting plan may reflect the received change to the model availability data for the first lot as well as the required changes to the model availability data for any of the lots in the set other than the first lot. Additionally, the method may include displaying a siting plan layout corresponding to the updated siting plan.

The method may also include identifying which lots in the set are adjacent to each other. In alternate embodiments, the method may additionally identify lots in the set that are across from each other, back to back to each other or kitty corner to each other. Additionally, the method may include determining at least one siting rule corresponding to each of the plurality of models. Determining any required change to the model availability for any of the lots in the set other than the first lot may involve applying the at least one siting rule corresponding to the first lot.

In some instances, for at least one model, the corresponding siting rule may require that the model may not be assigned to two adjacent lots. In addition or in the alternative, in some instances, for at least one model, the corresponding siting rule may require that the model must be assigned to two adjacent lots. As well, for at least one of the models the corresponding siting rule may require that the model may not be assigned to two lots less than a predetermined number of lots apart.

A computer-readable medium comprising instructions executable on a processor of a computing device for implementing the method(s) may also be provided.

Yet another broad aspect is directed towards a model display system for displaying at least one model sited on at least one lot. The system may include a siting plan database; a display; and an input module. The siting plan database may be provided with a plurality of lot records, with each lot record corresponding to one lot of a set of lots in a siting plan. As well, each lot record may include model availability data corresponding to the availability of a plurality of models for the corresponding lot. The model availability data may include at least one sited model image for each model available for the corresponding lot. The display may be operatively coupled to the siting plan database and configured to display siting plan data corresponding to the siting plan database. The display may be configured to display at least one sited model image. The input module may be configured to select a sited model image to display on the display.

In some instances, the input module may be configured to receive input corresponding to at least one change to the model availability data for a first lot. The system may also include an availability updating module operatively coupled to the input module and to the siting plan database, such that upon receipt of a change to the model availability data for a first lot, the availability updating module is configured to determine any required change to the model availability data for any other lot.

These and other aspects and features of various embodiments will be described in greater detail below.

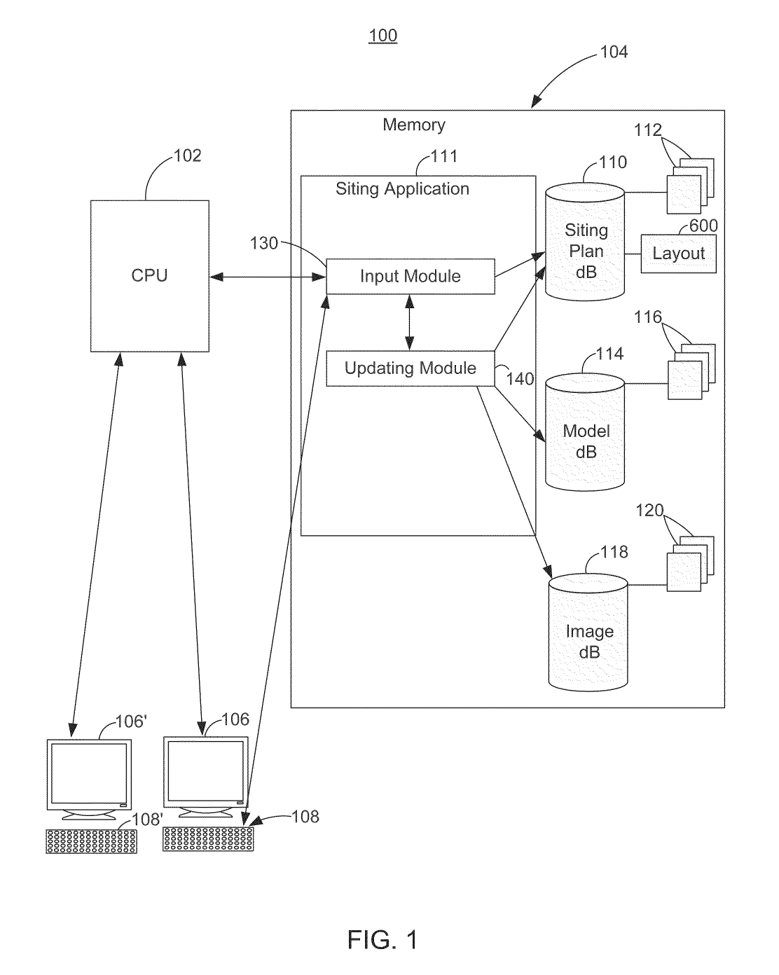

Referring first to FIG. 1, a block diagram of a siting plan system in one example implementation is shown generally as 100. System 100 comprises a number of components, including microprocessor 102 which may form part of a computer system. Microprocessor 102 controls the overall operation of system 100. Microprocessor 102 also interacts with additional subsystems such as memory storage 104 (which may include random access memory (RAM) and read-only memory (ROM), and persistent storage such as flash memory), display 106 (for example, a flat panel wall mounted display), and input device(s) 108, for example, such as a keyboard, mouse, touchscreen (which may form part of the display 106) or touchpad. Additional displays 106′ and input devices 108′ may also be provided. Operating system software used by microprocessor 102 is typically stored in a persistent store such as flash memory or read-only memory (ROM) or similar storage element (not shown). Those skilled in the art will appreciate that the operating system, specific device applications, or parts thereof, may be temporarily loaded into a volatile store such as RAM. In alternate embodiments, the described databases may be implemented as remote databases that may be accessible by siting application 111 across computer networks (including the Internet) through database server software. In further alternate embodiments, siting application 111 and the described databases may be implemented on a remote server such that the siting application 111 is running on CPU 102 and memory 104 in one geographical location, and users accessing the siting application 111 (e.g., through a web browser or a “thin” client) are in another geographical location.

Microprocessor 102, in addition to its operating system functions, enables execution of software applications which may include a siting application program 111, typically stored in storage 104 and programmed to cause the CPU 102 to provide the functionality discussed herein. The system 100 may also include within the storage 104 a siting plan database 110, which includes a lot record 112 for each of the lots in the siting plan, as well a model database 114 having a model record 116 for each of the housing models.

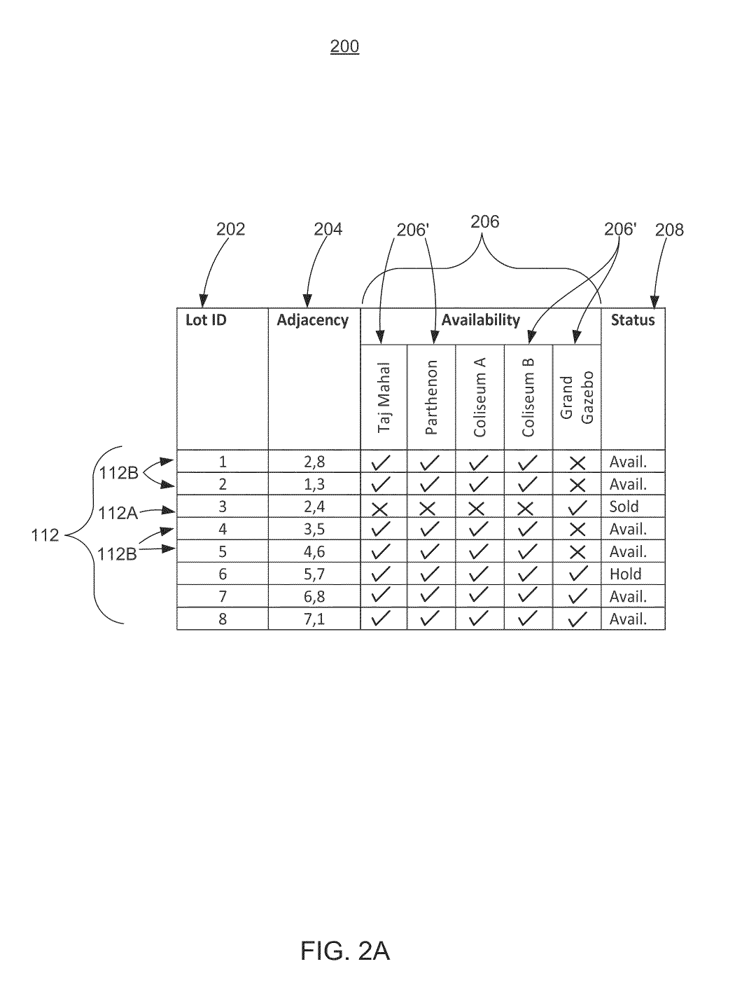

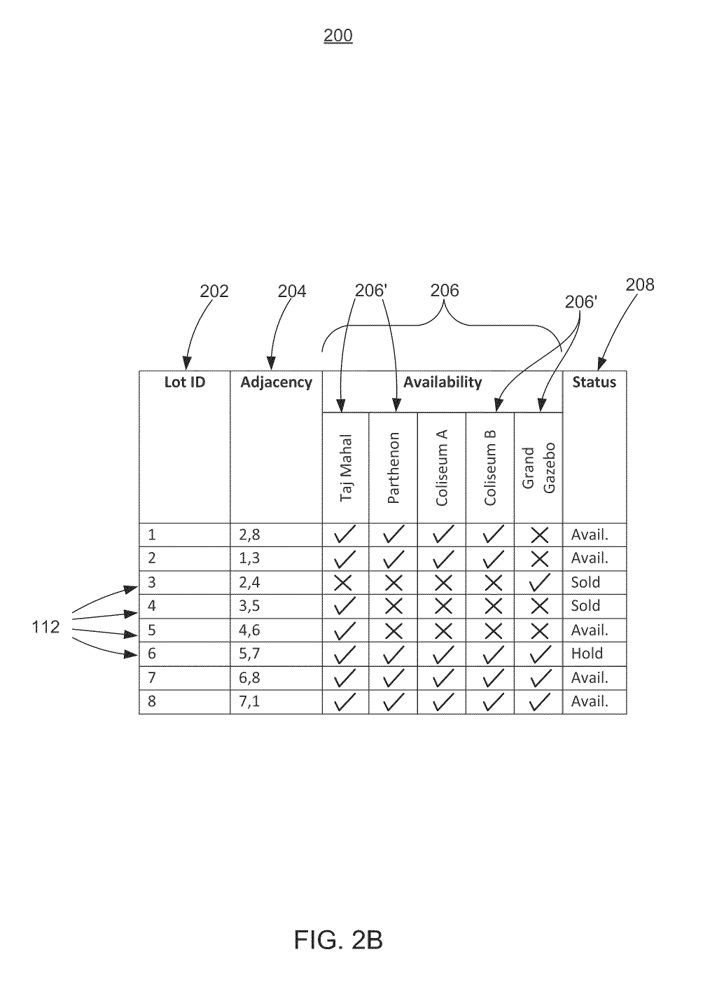

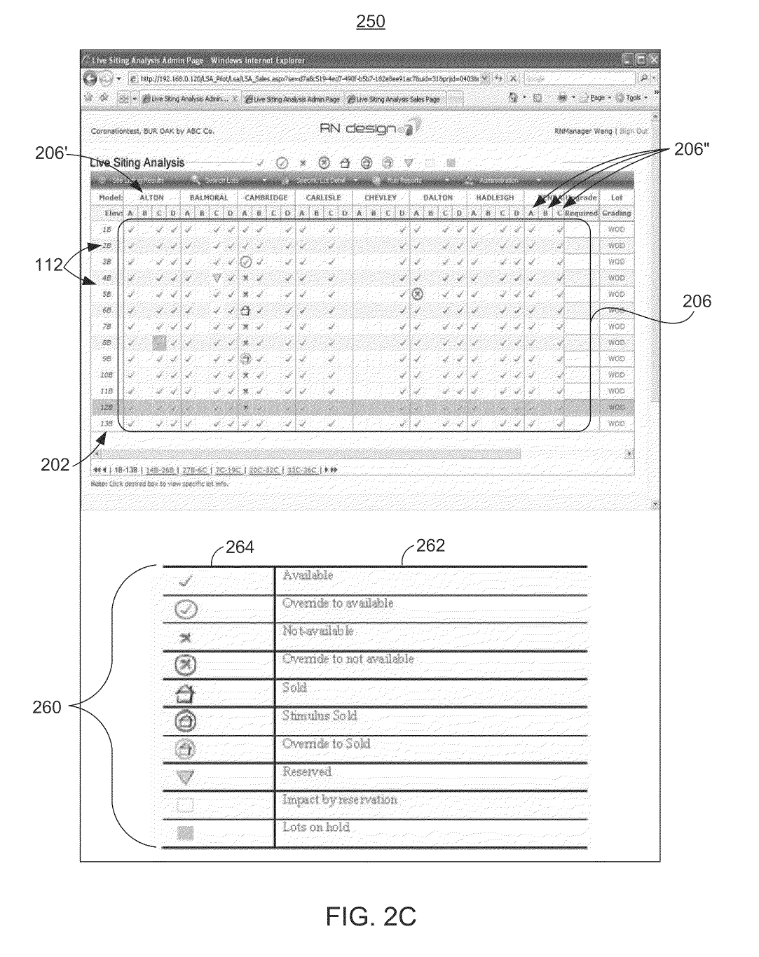

Referring briefly to FIG. 2A, illustrated therein is a schematic illustration of a siting plan matrix (a representation of a siting plan in chart form), shown generally as 200, comprising example lot records 112 containing exemplary data, as may be saved in the siting plan database 110. Each record 112 corresponds to one lot in the set of lots in the siting plan or development project. The data stored in each lot record 112 may include a lot identifier 202 (such as a lot number), together with relationship data 204 identifying any lots (typically in the form of identifiers corresponding to the appropriate lot identifiers 202) which are related to the lot 202. Although FIG. 2A illustrates lots that are adjacent to lot 202 for the purposes of relationship data 204, it should be understood that in alternate embodiments, additional relationship data (for example, lots across from each other, lots back to back to each other, or kitty corner to each other) may also be present. Additionally, each lot record 112 also stores model availability data 206 corresponding to the availability of a plurality of models 206′ for the corresponding lot 202 (As a pictorial illustration, availability data 206 in FIG. 2 use a checkmark (“✓”) to indicate a given model is available, and an “X” to indicate a model is unavailable for the corresponding lot 202). Each lot record 112 may also include status data 208 corresponding to the status of the lot 202 (eg. “Available”, “Sold”, “Hold” (or reserved), etc.) It should be understood that in alternate embodiments, similar or different relationship, availability, and status data may be stored, and may be stored separately in other databases or other tables within the same database.

Referring briefly to FIG. 2C, illustrated therein is a screenshot, shown generally as 250, illustrating an alternate embodiment of a portion of a siting plan matrix having example lot records 112, illustrating numerous models 206′ and model elevations 206″ for a plurality of lots 202. The screenshot 250 includes a legend 260 identifying the meaning 262 of the various status/availability icons 264 reflecting both the model availability data 206 and status data of this embodiment.

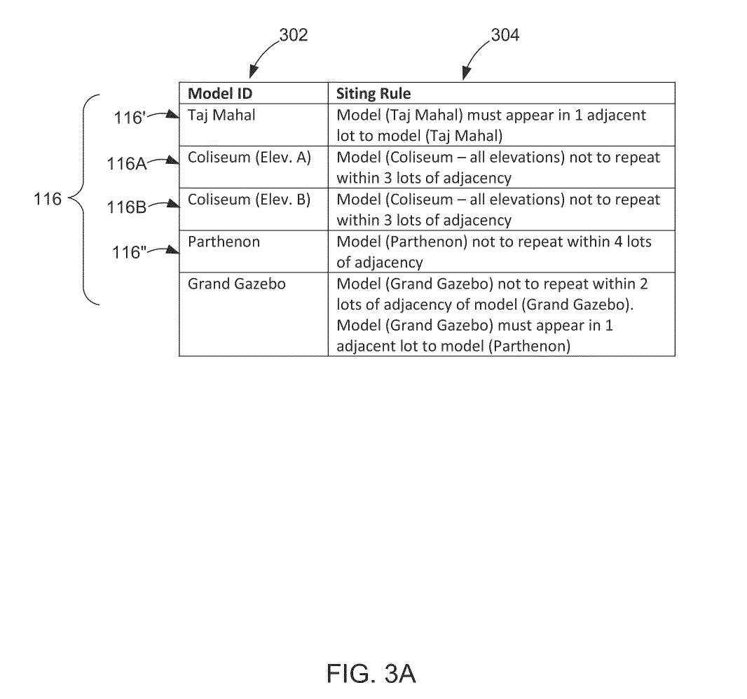

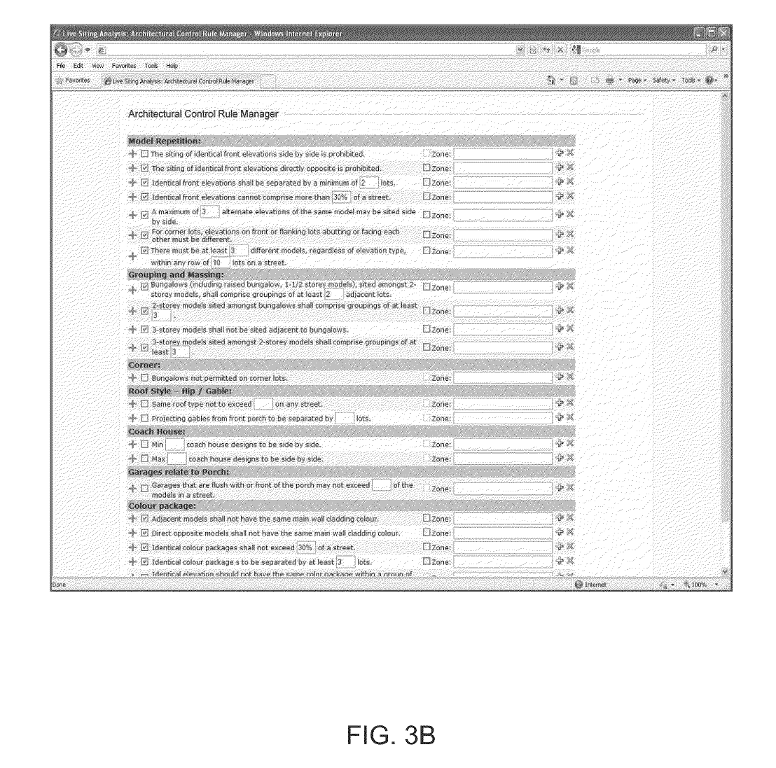

Referring briefly to FIG. 3A, illustrated therein is a schematic illustration of example model records 116 containing exemplary data as may be stored in the model database 114. The data stored in each model record 116 may include a model identifier 302 (such as a model name), together with at least one architectural/siting rule 304 for the corresponding model 302. As illustrated in FIG. 3A, separate model records 116A, 116B may also be provided for each elevation of a particular model. As previously noted, siting rules 304 specify where and how often a model 302 may or must reappear in lots 202 typically in close proximity to each other. For example, in the record 116′ for the “Taj Mahal” duplex model 302, the corresponding siting rule 304 specifies that (because it is a duplex) the same “Taj Mahal” duplex model 302 must also appear in an immediately adjacent lot. In another example, in the record 116″ for the “Parthenon” model 302, the corresponding siting rule 304 specifies that the “Parthenon” model 302 may not be repeated unless separated by four consecutive adjacent lots. As will be understood, in some embodiments, a model 302 may be provided with multiple and/or alternate siting rules 304 such as those illustrated in FIG. 3B, depending on the desired and/or required architectural restrictions for the development project.

In further alternate embodiments, architectural/siting rules may in addition, or in the alternative, be stored with lot records 112 in siting plan database 110 to provide architectural rules that are lot-based. Such embodiments may restrict or require the placement of models according to lots. For example, a typical rule is that identical models (same model and elevation) must be separated by at least 2 lots. Such a rule applies for all lots without regard to the type of model sited on a lot. Thus, in such an embodiment, the architectural/siting rules may be configured to be lot-based.

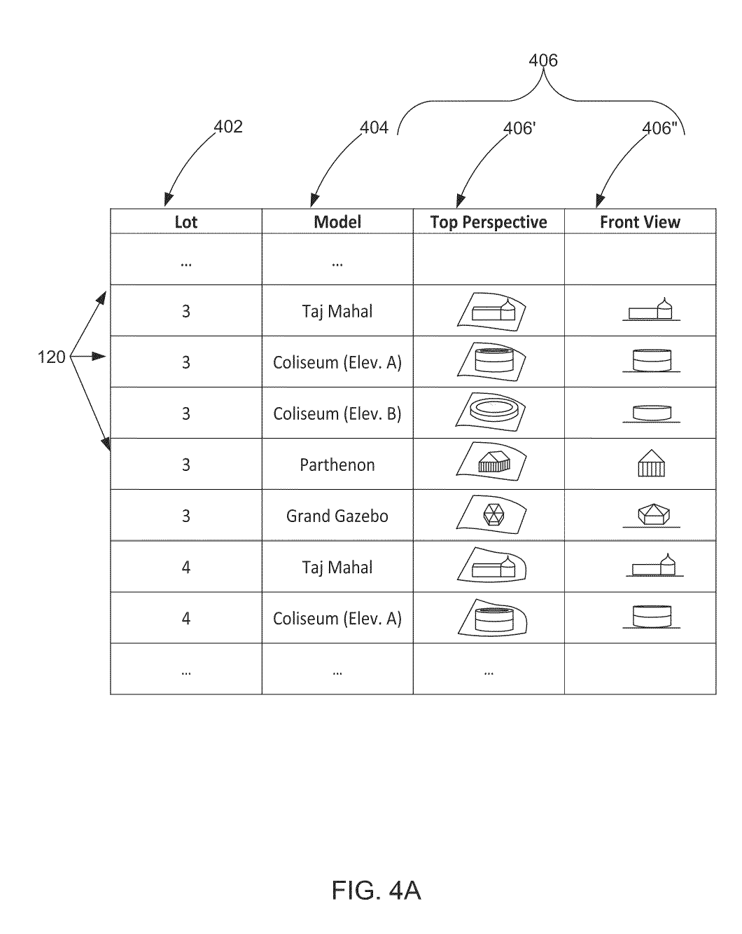

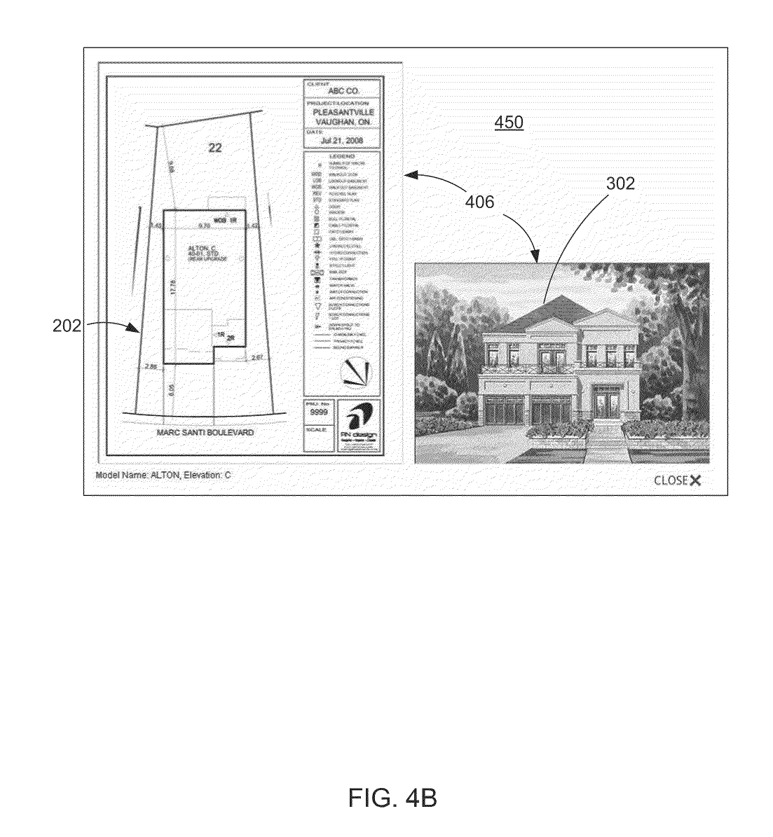

The system 100 may also be provided with an image database 118 containing a plurality of image records 120 and operatively coupled to the siting plan database 110. Referring briefly to FIG. 4A, depicted therein is a schematic illustration of example image records 120 containing exemplary data as may be stored in the image database 118. Each image record 120 corresponds to a lot 202/model 302 combination, and accordingly may be provided with lot 402 and model 404 identifiers, typically corresponding to the lot 202 and model 302 identifiers used in the siting plan database 110 and model database 114, respectively. Each image record 120 may also be provided with one or more diagrams or images 406 of the model 302 as sited on the corresponding lot 202 (if such model 302 can be sited on the lot 202). For example, top perspective images 406′ of the model sited on the lot may be provided and in some instances front, side and/or rear views 406′ of the models may also be provided. In some instances, for example if a model 302 is too large to be sited on a lot 202 or if a specific model 302 cannot be sited on two adjacent lots 202, a corresponding image 406 may not be provided (In such instances, alternate embodiments may still display the corresponding image 406 but with warnings that the model 302 may need to be modified or adjusted for a desired lot 202.) As will be understood, the siting application 111 may be configured to selectively display such images 406 on the display 106 to assist a potential buyer in visualizing particular model 302/lot 202 combinations and thereby facilitate the potential buyer's decision-making process. Referring briefly to FIG. 4B, illustrated therein is an example screenshot 450 of exemplary images 406 of a particular model 302 sited on a particular lot 202, as may be presented on the display 106 to assist a potential buyer. In some embodiments, the image data 406 may be 3-dimensional such that a 3D virtual representation of the model 302 and the site plan layout 600 (discussed below) may be displayed.

The system 100 will also typically include an input module 130 which may comprise part of the siting application 111 and be operatively coupled to the input device(s) 108 and to the siting plan database 110. The input module 130 may be configured to receive input from a user to select the image(s) 406 to be displayed on the display 106 to assist a potential buyer in visualizing particular model 302/lot 202 combinations, as noted above. Upon a user making a decision regarding a particular lot 202 (eg. the potential buyer deciding to purchase the lot 202 with a particular model 302 to be built on it; or the lot 202 is to be put on hold or reserved for a potential buyer (or the status 208 for the lot 202 is to be amended, etc.), the input module 130 is configured to receive decision input corresponding to such a decision.

The system 100 is also provided with an updating module 140 (which may also comprise part of the siting application 111) operatively coupled to the input module 130 and to the siting plan database 110. Upon receipt of the decision input regarding a particular lot 202 by the input module 130, the updating module is configured to be able to update the corresponding lot record 112 as necessary in accordance with the decision input. For example, in the instance of the decision input corresponding to a potential buyer deciding to purchase the lot 202 with a particular model 302 to be built, the model availability data 206 is updated to reflect the designation of the model 302.

The updating module 140 may also be configured to utilize the relationship data 204 and apply the siting rules 304 for the particular model 302 (if any) affected by the decision input, to update the appropriate lot records 112. Referring briefly to FIG. 2A, the lot record 112A indicates that (pursuant to a decision input) “Lot 3” has been “Sold”, with the “Grand Gazebo” to be built on it. The lots 112B in sufficient proximity to “Lot 3” 112A, have been updated by the updating module 140 in accordance with the siting rule 304 for the “Grand Gazebo” model 302 to indicate that the “Grand Gazebo” model 302 is unavailable to be built on such “neighboring” lots 112B.

Similarly, referring briefly to FIG. 2B, upon receipt of a decision input that “Lot 4” has been “Sold”, with the “Taj Mahal” model to be built on it, the updating module 140 has correspondingly updated the lot record 112 to reflect such sale. In accordance with the siting rule 304 corresponding to the model record 116′ for the “Taj Mahal” model 302, the updating module 140 has updated the lot record 112 for “Lot 5” to reflect that only the “Taj Mahal” model 302 is available since the rule reflects the townhouse nature of the “Taj Mahal” model 302 (and the updating module 140 has noted that “Lot 3” is already “Sold” and therefore unavailable to be the second portion of the “Taj Mahal” townhouse model 302). Such input and updating may be repeated throughout the sales process.

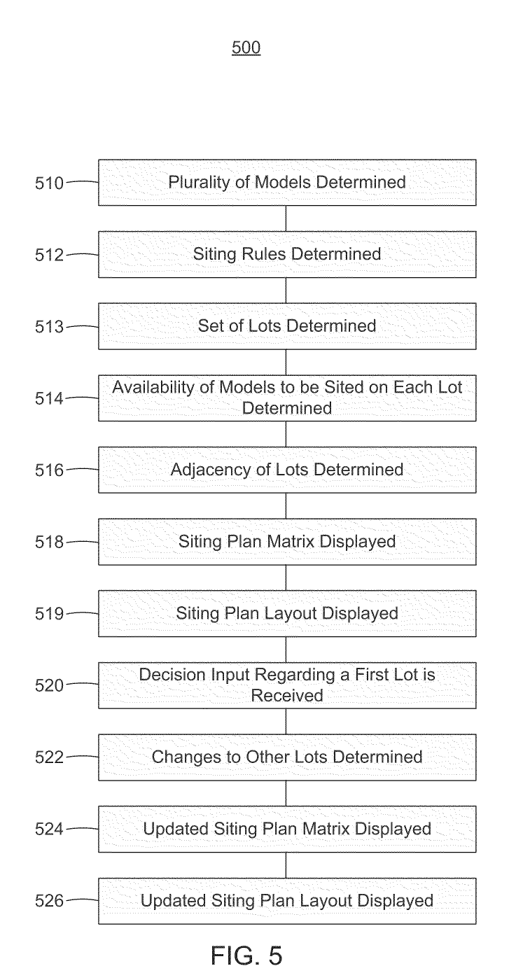

Referring now to FIG. 5, a flowchart illustrating steps of a method of displaying an active siting plan corresponding to a set of lots 202, in accordance with at least one embodiment, is shown generally as 500. Additional details of some of the features described below in respect of the steps of method 500 may be described elsewhere in the present specification.

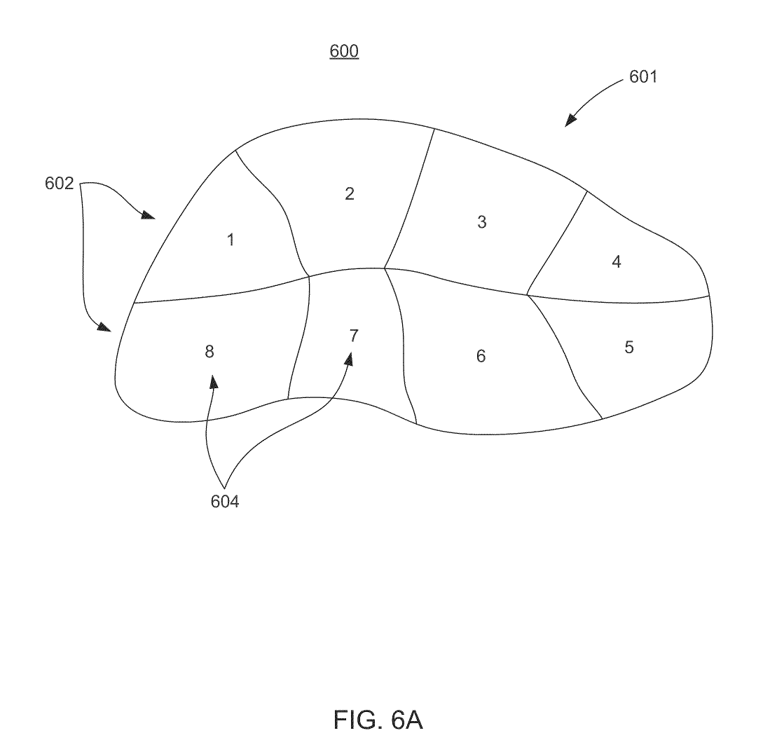

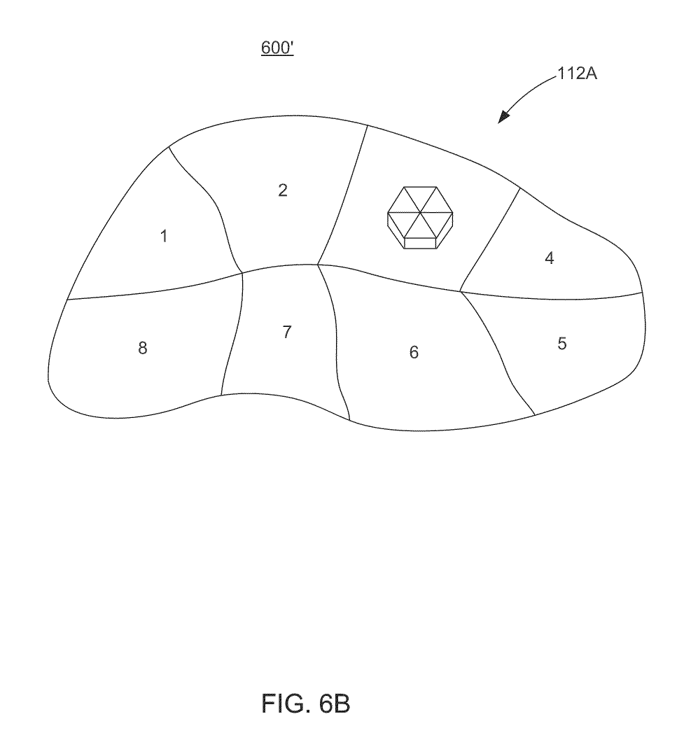

Referring briefly to FIG. 6A, illustrated therein is a top plan view of an example siting plan layout, shown generally as 600, corresponding to a proposed development. The example siting plan layout 600 comprises a plurality or set 601 of lots 602, having lot identifiers 604 corresponding to the lot identifiers 202 in the lot records 112. The siting plan layout 600 will typically be stored in the siting plan database 110 for graphical display on the display 106.

In one embodiment, the steps of method 500 are performed by an application(s) (e.g. siting application 111 of FIG. 1) that typically executes and resides on the CPU 102. The application need not be a stand-alone application, and the functionality described herein may be implemented in one or more applications executing and residing on the CPU 102 or remotely.

At Block 510 the plurality of models 302 available to be sold is determined. Typically the models will be designed to complement each other esthetically and/or financially in order that the development of the lots is cohesive. Typically, as discussed above, at least one siting rule is determined and stored for each model 302 (Block 512). As previously noted, for example, a siting rule may require that a particular model 302 may not be assigned to two adjacent lots. A different siting rule may require that the same model 302 must be assigned to two adjacent lots. Another siting rule may require that the same model 302 may not be assigned to two lots less than a predetermined number of lots apart. Different siting rules may be developed for different real estate development projects, and as noted, multiple siting rules may be determined or required for a model 302.

The set 601 of lots 602 available to be sold is also determined (Block 513).

The availability of each model 302 to be sited on each lot 202 is determined (Block 514). In the first instance, a model 302 is considered to be available to be sited on a lot 202 if the lot 202 is sufficiently sized and shaped to be able to accommodate the footprint (or outline) of the model 302 while meeting any necessary setbacks or other particular zoning requirements as may be required for the lot 202. The model availability data 206 for each lot record 112 may be stored. The availability may be determined by comparing each model footprint to each lot 202 manually, or automatically. Typically, the availability in the first instance is determined without regard to the siting rules determined in Block 512.

Additionally, as discussed previously, the relationship of each of the lots 202 in the set may be determined and provided (Block 516).

Some portion or all of the siting plan matrix 200 may be displayed, for example on the display 106, listing the model availability 206 for each lot 202 (Block 518). Additionally, in some embodiments the siting plan layout 600 may also be displayed on the display 106 or otherwise combined with the siting plan matrix 200 (Block 519). As previously noted, a change or decision input regarding a particular lot 202 may be input via the input devices 108 and received by the input module 130 (Block 520). The updating module is configured to be able to update the corresponding lot record 112 as necessary in accordance with the decision input. For example, in the instance of the decision input corresponding to a potential buyer deciding to purchase a lot 202 with a particular model 302 to be built, the model availability data 206 is updated to reflect the designation of the model 302.

The updating module 140 may also be configured to utilize the relationship data 204 and apply the siting rules 304 for the particular model 302 (if any) affected by the decision input, to update the appropriate lot records 112 for any other of the lots 202 in the set with any required changes (Block 522). Once the updating module 140 has updated the lot records 112 with any required changes, the updated siting plan matrix 200 may be displayed on the display 106 (Block 524).

Additionally, in some embodiments the updating module 140 may also be configured to update the siting plan layout 600 to reflect the decision input as necessary, and the updated siting plan layout 600 may also be displayed on the display 106 or otherwise combined with the updated siting plan matrix 200 (Block 526). As noted, typically the decision input will reflect that a particular model 302 has been selected for a particular lot 202. In such instances, the siting plan layout 600 will be updated to incorporate the corresponding model image 120 for the lot 202/model 302 combination corresponding to the decision input. Referring briefly to FIG. 6B, illustrated therein is an example updated siting plan layout, shown generally as 600′, in which the siting plan layout 600 of FIG. 6A has been updated as a result of decision input corresponding to the sale of the “Grand Gazebo” model 302 for lot “3” 112A. By updating and displaying the siting plan layout 600, prospective buyers can have a better idea of how the development or neighbourhood may appear, which may influence a potential decision to purchase.

It will be understood by persons skilled in the art that the features of the user interfaces illustrated with reference to the example screenshots, siting plans and layouts described herein are provided by way of example only. It will be understood by persons skilled in the art that variations are possible in variant implementations and embodiments.

The steps of a method in accordance with any of the embodiments described herein may be provided as executable software instructions stored on computer-readable media, which may include transmission-type media. Such steps may not be required to be performed in any particular order, whether or not such steps are described in claims or otherwise in numbered or lettered paragraphs.

The invention has been described with regard to a number of embodiments. However, it will be understood by persons skilled in the art that other variants and modifications may be made without departing from the scope of the invention as defined in the claims appended hereto.

1. A model availability system for determining the availability of at least one model to be sited on at least one lot, comprising:
(a) a siting plan database comprising a plurality of lot records, wherein each lot record corresponds to one lot of a set of lots in a siting plan, and wherein each lot record comprises model availability data corresponding to the availability of a plurality of models for the corresponding lot;
(b) a display operatively coupled to the siting plan database and configured to display siting plan data corresponding to the siting plan;
(c) an input module configured to receive input corresponding to at least one change to the model availability data;
(d) an availability updating module operatively coupled to the input module and to the siting plan database, wherein upon receipt of a change to the model availability data for a first lot, the availability updating module is configured to determine any required change to the model availability data for any other lot.

2. The system as claimed in claim 1, wherein the siting plan database comprises related lot data identifying how at least two lots are related.

3. The system as claimed in claim 2, wherein the availability updating module is configured with at least one siting rule for determining if a change is required to the model availability data for a lot.

4. The system as claimed in claim 3, further comprising a model database operatively coupled to the availability updating module, wherein the model database comprises a plurality of model records wherein each model record corresponds to one of the models.

5. The system as claimed in claim 4, wherein each model record comprises at least one siting rule for the corresponding model.

6. The system as claimed in claim 4, wherein the at least one siting rule requires that for at least one of the models, the model may not be assigned to two adjacent lots.

7. The system as claimed in claim 4, wherein the at least one siting rule requires that for at least one of the models, the model must be assigned to two adjacent lots.

8. The system as claimed in claim 4, wherein the at least one siting rule requires that for at least one of the models, the model may not be assigned to two lots less than a predetermined number of lots apart.

9. The system as claimed in claim 5, wherein the availability updating module is configured to apply the at least one siting rule corresponding to the first lot.

10. The system as claimed in claim 3 wherein the display is configured to display a siting plan layout corresponding to the siting plan.

11. A method of displaying the availability for at least one model to be sited on a set of at least one lot of a siting plan, the method comprising:
(a) determining the at least one model;
(b) determining the availability of each model to be sited on each lot;
(c) displaying siting plan data corresponding to the siting plan, wherein the siting plan data indicates the model availability for each lot;
(d) receiving a change to the model availability corresponding to a first lot in the set;
(e) determining any required change to the model availability for any of the lots in the set other than the first lot; and
(f) displaying siting plan data corresponding to an updated siting plan, wherein the updated siting plan comprises the changes to the model availability data from steps (d) and (e).

12. The method as claimed in claim 11, further comprising identifying which lots in the set are adjacent to each other.

13. The method as claimed in claim 12, further comprising determining at least one siting rule corresponding to each of the plurality of models.

14. The method as claimed in claim 13, wherein for at least one model, the corresponding siting rule requires that the model may not be assigned to two adjacent lots.

15. The method as claimed in claim 13, wherein for at least one model, the corresponding siting rule requires that the model must be assigned to two adjacent lots.

16. The method as claimed in claim 13, wherein for at least one model, the corresponding siting rule requires that for at least one of the models, the model may not be assigned to two lots less than a predetermined number of lots apart.

17. The method as claimed in claim 13, wherein determining any required change to the model availability for any of the lots in the set other than the first lot comprises applying the siting rule corresponding to the first lot.

18. The method as claimed in claim 11, further comprising displaying a siting plan layout corresponding to the updated siting plan.

19. A computer-readable medium comprising instructions executable on a processor of a computing device for implementing the method of claim 11.

20. A model display system for displaying at least one model sited on at least one lot, comprising:
(a) a siting plan database comprising a plurality of lot records, wherein each lot record corresponds to one lot of a set of lots, and wherein each lot record comprises model availability data corresponding to the availability of a plurality of models for the corresponding lot;
(b) wherein the model availability data comprises at least one sited model image for each model available for the corresponding lot;
(c) a display operatively coupled to the siting plan database and configured to display siting plan data corresponding to the siting plan database;
(d) wherein the display is further configured to display at least one sited model image; and
(e) an input module configured to select a sited model image to display on the display.

21. The system as claimed in claim 20, wherein the input module is further configured to receive input corresponding to at least one change to the model availability data for a first lot.

22. The system as claimed in claim 21, further comprising an availability updating module operatively coupled to the input module and to the siting plan database, wherein upon receipt of a change to the model availability data for a first lot, the availability updating module is configured to determine any required change to the model availability data for any other lot.
